(19) United States
(12) Patent Application Publication
(10) Pub. No.: US 2015/0292866 A1
(43) Pub. Date: Oct. 15, 2015

(54) FILM THICKNESS MEASUREMENT DEVICE AND METHOD

(71) Applicants: Otsuka Electronics Co., Ltd., Osaka (JP); JOLED INC., Tokyo (JP)

(72) Inventors: Yuki SASAKI, Osaka (JP); Tomoya NONOMURA, Yokohama-shi (JP)

(73) Assignees: Otsuka Electronics Co., Ltd.; JOLED INC.

(21) Appl. No.: 14/685,596

(22) Filed: Apr. 14, 2015

(30) Foreign Application Priority Data
Apr. 14, 2014 (JP) 2014-083214

(51) Int. Cl. G01B 11/06

(52) U.S. Cl. CPC G01B 11/0641

(57) ABSTRACT

To measure an inclination of a sample caused due to the warping of the sample, a film thickness measurement device includes: a light projection ellipsometric head for radiating polarized measuring light on a sample; a light reception ellipsometric head for receiving reflected light of the polarized measuring light, to thereby acquire a polarization state of the reflected light; a microscope camera for measuring a height of a surface of the sample at each of a plurality of measurement positions; and a control portion for calculating an inclination on the surface of the sample based on the height measured at the each of the plurality of measurement positions, and calculating a thickness of a film formed on the surface of the sample based on the calculated inclination on the surface of the sample and the polarization state of the reflected light.

### CROSS-REFERENCE TO RELATED APPLICATION

The present application claims priority from Japanese application JP 2014-083214 filed on Apr. 14, 2014, the content of which is hereby incorporated by reference into this application.

### BACKGROUND OF THE INVENTION

1. Field of the Invention

The present invention relates to a film thickness measurement device and method, and more particularly, to measurement of a film thickness using the ellipsometry.

2. Description of the Related Art

The ellipsometry has been known as a method of measuring a thickness of a thin film formed on a sample surface. This method utilizes a phenomenon that, when light is reflected on the sample surface, the polarization state is changed before and after the reflection depending on parameters including an incident angle, a film thickness, and a complex refractive index. In this case, the film thickness and the like are generally calculated on the assumption that the incident angle of the light is known among the above-mentioned parameters.

However, the sample surface and a measurement reference surface are not practically always parallel to each other, and an actual incident angle is not necessarily equal to when the sample surface has an inclination. Then, this difference leads to a measurement error. In view of this, in Japanese Patent Application Laid-open No. 2008-275632, it is disclosed that an auxiliary light source portion is arranged separately from a measurement light source portion serving as an ellipsometer. A sample is irradiated with white light that is generated from auxiliary light from the auxiliary light source portion and has, for example, a cross pattern, and at the same time, reflected light of the white light is photographed, to thereby calculate an inclination on the sample based on a position of the pattern on the photographed image. Then, an accurate incident angle is obtained from the thus obtained inclination, and at the same time, ellipsometry is performed on a film formed on the sample surface based on the acquired polarization state. In this way, an optical constant, a thickness, and the like of the film can be acquired.

However, the above-mentioned related art has a problem in that the auxiliary light source portion needs to be arranged separately from the measurement light source portion serving as the ellipsometer, and hence the configuration of the device is complicated.

### SUMMARY OF THE INVENTION

The present invention has been made in view of the above-mentioned problem, and thus has an object to provide a film thickness measurement device and method that are capable of acquiring an optical constant, a thickness, and the like of a film formed on a sample surface even if the sample warps to cause an inclination on the sample surface. Specifically, with a relatively simple device configuration, the inclination on the sample surface can be relatively easily measured so that an accurate incident angle is obtained, and at the same time, ellipsometry is performed on the film based on a polarization state acquired together with the incident angle.

A film thickness measurement device according to one embodiment of the present invention includes: a light projection portion for radiating polarized measuring light on a sample; a light reception portion for receiving reflected light of the polarized measuring light, to thereby acquire a polarization state of the reflected light; height measurement means for measuring a height of a surface of the sample at each of a plurality of measurement positions; inclination calculation means for calculating an inclination on the surface of the sample based on the height measured at the each of the plurality of measurement positions; and film thickness calculation means for calculating a thickness of a film formed on the surface of the sample based on the calculated inclination on the surface of the sample and the polarization state of the reflected light.

Further, a film thickness measurement method according to one embodiment of the present invention includes: radiating polarized measuring light on a sample; receiving reflected light of the polarized measuring light, to thereby acquire a polarization state of the reflected light; measuring a height of a surface of the sample at each of a plurality of measurement positions; calculating an inclination on the surface of the sample based on the height measured at the each of the plurality of measurement positions; and calculating a thickness of a film formed on the surface of the sample based on the calculated inclination on the surface of the sample and the polarization state of the reflected light.

In this case, the height measurement means may be arranged to be movable along with a predetermined measurement reference surface. Further, the inclination calculation means may calculate the inclination on the surface of the sample with respect to the predetermined measurement reference surface.

Further, the light reception portion may include a light condensing optical system for condensing the reflected light having a traveling direction that is changeable depending on the inclination on the surface of the sample.

In addition, the height measurement means may be arranged between the light projection portion and the light reception portion, and may include a camera for photographing a radiation position of the polarized measuring light. The height measurement means may be configured to measure the height of the surface of the sample based on a result of focusing of the camera.

### BRIEF DESCRIPTION OF THE DRAWINGS

FIG. 1 is a schematic diagram of a configuration of a film thickness measurement device according to an embodiment of the present invention.

FIGS. 2A and 2B are views illustrating an example of a change in incident angle due to warping of a sample.

FIG. 3 is a plan view of the sample, illustrating an example of a height measurement position on the sample.

FIG. 4 is a flow chart of operation of the film thickness measurement device according to the embodiment of the present invention.

### DETAILED DESCRIPTION OF THE INVENTION

A description is made below in detail of an embodiment of the present invention with reference to the drawings.

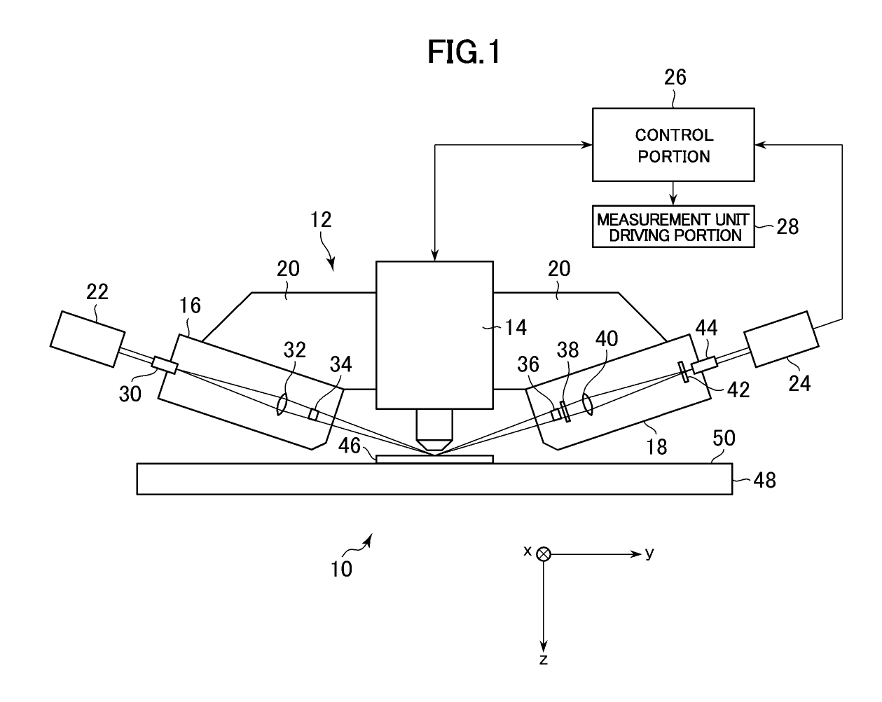

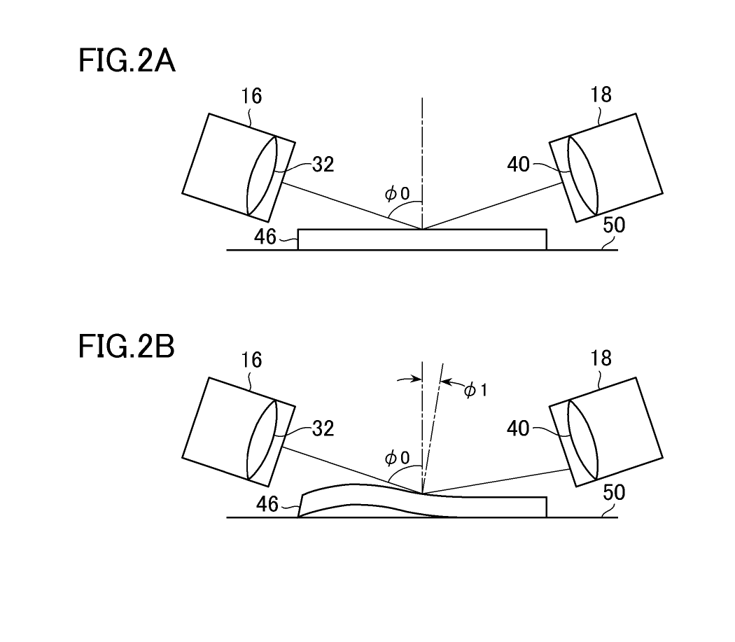

FIG. 1 is a schematic diagram of a configuration of a film thickness measurement device according to an embodiment of the present invention. As illustrated in FIG. 1, a film thickness measurement device 10 includes a light projection ellipsometric head 16 and a light reception ellipsometric head 18 that are arranged so as to be directed to a sample 46 from directions opposite to each other. The sample 46 is mounted on a sample stage 48 arranged horizontally, and an upper surface of the sample stage 48 serves as a measurement reference surface 50. The light projection ellipsometric head 16 is connected to a distal end portion of a light projecting fiber 30 connected to a light source 22 for emitting a single-wavelength laser beam. Measuring light is emitted from the distal end portion of the light projecting fiber 30. A lens 32 and a polarizer 34 are arranged in the stated order in front of the light projecting fiber 30. The measuring light, which is condensed by the lens 32, is linearly-polarized by the polarizer 34 at 45°, and then enters a surface of the sample 46 at an incident angle φ0 with respect to the measurement reference surface 50. As illustrated in FIG. 2A, when the sample 46 is completely flat, the measuring light enters the surface of the sample 46 at the incident angle φ0. A thin film is formed on the surface of the sample 46, and hence the measuring light reflected on the surface of the sample 46 becomes elliptically-polarized light.

When the surface of the sample 46 is completely flat, the measuring light is reflected on the surface of the sample 46 in a direction having the angle φ0 with respect to the measurement reference surface 50. The light reception ellipsometric head 18 is arranged so that an optical axis thereof matches with a path of the measuring light reflected at the reflection angle φ0. The light reception ellipsometric head 18 includes, in order from the sample 46 side, a rotating analyzer 36, a depolarizing plate 38, a lens 40, and a diffuser plate 42. The measuring light passes through those components in the stated order to enter a distal end portion of a light receiving fiber 44.

In this case, in the film thickness measurement device according to the embodiment of the present invention, the light reception ellipsometric head 18 is arranged so that the optical axis thereof matches with the path of the measuring light reflected at the reflection angle φ0 as described above, and at the same time, is arranged on an optical path of the lens 40 serving as a light condensing optical system. With this configuration, as illustrated in FIG. 2B, the measuring light can be guided to the light receiving fiber 44 even if the surface of the sample 46 has an inclination and the incident angle and the reflection angle thus deviate to φ0+φ1.

Accordingly, even if the surface of the sample 46 has the inclination, the reflection of the measuring light from the light projection ellipsometric head 16 can be taken by the light reception ellipsometric head 18 with a small loss.

The light receiving fiber 44 guides the measuring light to a photomultiplier 24 where light intensity of the measuring light is detected. The light intensity of the measuring light is input to a control portion 26 constructed by a computer so that ellipsometric parameters (Ψ, Δ) indicating a polarization state of the measuring light are calculated. In this case, symbol Ψ represents an amplitude ratio between a polarization component P and a polarization component S, and symbol Δ represents a phase difference therebetween. Moreover, the control portion 26 calculates a thickness of the film formed on the surface of the sample 46 from the ellipsometric parameters (Ψ, Δ).

In the film thickness measurement device 10 according to this embodiment, a microscope camera 14 is arranged between the light projection ellipsometric head 16 and the light reception ellipsometric head 18. The microscope camera 14 is arranged in a direction perpendicular to the measurement reference surface 50, and photographs an incident position of the measuring light on the sample 46. The photographed image is input to the control portion 26 to be displayed on a display. A user can confirm the incident position of the measuring light on the sample 46 from this image.

The light projection ellipsometric head 16, the light reception ellipsometric head 18, and the microscope camera 14 are fixed to each other by a bracket 20. Those components are integrated to form a measurement unit 12. The measurement unit 12 can be translationally moved in three directions and be relatively moved with respect to the sample 46 and the sample stage 48 by a measurement unit driving portion 28 including an actuator such as a motor. In other words, the measurement unit 12 can move in a direction perpendicular to the measurement reference surface 50 (z-direction). Further, the measurement unit 12 can also move in a direction of a line obtained by projecting the path of the measuring light on the measurement reference surface 50 (y-direction). In addition, the measurement unit 12 can also move in an x-direction perpendicular to the above-mentioned y-direction and z-direction. Note that, the measurement unit driving portion 28 moves the measurement unit 12 herein, but the sample stage 48 may be moved instead.

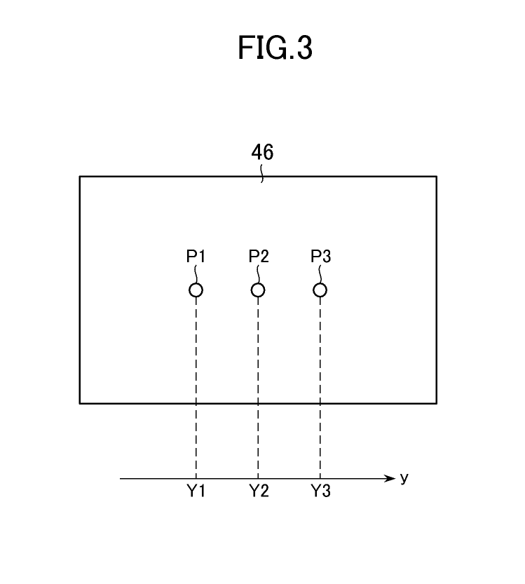

Before the ellipsometric parameters (Ψ, Δ) and the film thickness are calculated, the control portion 26 measures the inclination on the surface of the sample 46. Specifically, as illustrated in FIG. 3, the microscope camera 14 is focused on three points of a position P2 serving as a film thickness measurement position, a position P1 separated away from the position P2 on the light projection ellipsometric head 16 side, and a position P3 separated away from the position P2 on the light reception ellipsometric head 18 side. The microscope camera 14 is a fixed-focus camera, and hence the focusing of the microscope camera 14 is performed through the movement of the measurement unit 12 (namely, microscope camera 14) in the z-direction by the measurement unit driving portion 28. The image photographed by the microscope camera 14 is input to the control portion 26. The control portion 26 determines, based on information on the clarity of the input image and the like, whether or not the microscope camera 14 is focused on the surface of the sample 46. Then, the measurement unit is moved in the z-direction (vertical direction) by the measurement unit driving portion 28 until the microscope camera 14 is focused on the surface of the sample 46. A position of the microscope camera 14 in the z-direction when the microscope camera 14 is focused on the surface of the sample 46 is equivalent to a height of the sample 46. Thus, the control portion 26 obtains the heights of the surface of the sample 46 together with position coordinates Y1, Y2, and Y3 in the y-direction at the above-mentioned three positions P1 to P3.

The control portion 26 calculates an inclination on the surface of the sample 46 at the position P2 serving as a film thickness measurement position based on the heights of the surface of the sample 46 at the positions P1 to P3 serving as height measurement positions and the y-coordinates Y1, Y2, and Y3 of the respective height measurement positions. For example, an inclination between the positions P1 and P2 and an inclination between the positions P2 and P3 may be calculated to take the average therebetween. Note that, the number of the height measurement positions is herein three, but arbitrary two positions may be used. The thus calculated inclination on the surface of the sample 46 is converted into the angle φ1 of FIG. 2B, and the corrected incident angle φ0+φ1 of the measuring light for the film thickness is calculated. This corrected incident angle φ0+φ1 is used for calculating the ellipsometric parameters (Ψ, Δ).

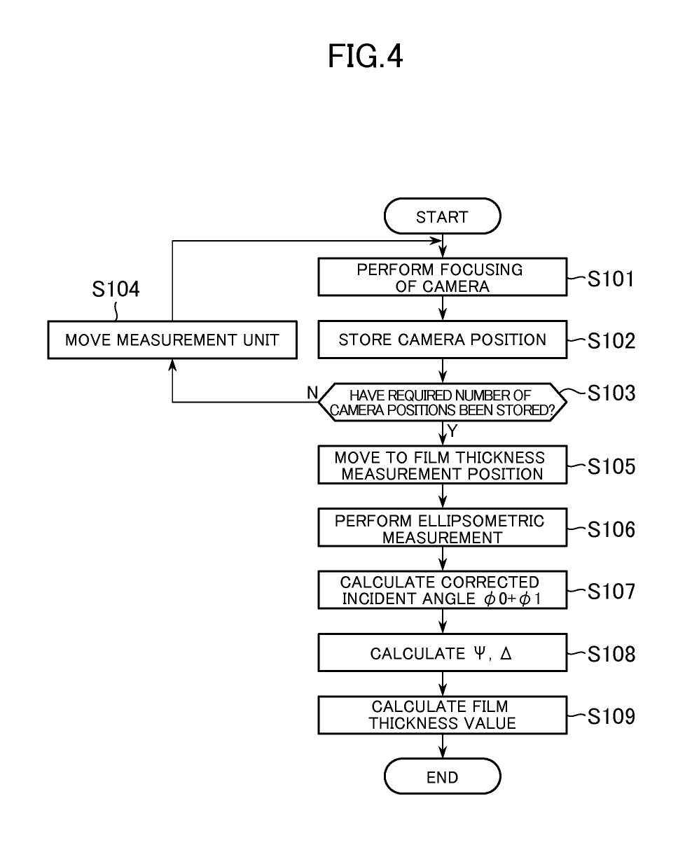

FIG. 4 is a flow chart of operation of the film thickness measurement device 10 according to the embodiment of the present invention. In a case where the thickness of the film formed on the surface of the sample 46 is measured, the control portion 26 first operates to move the microscope camera 14 (measurement unit 12) to a predetermined height measurement position for focusing (S101). The height measurement position includes, for example, at least two points of the film thickness measurement position P2 and at least one of the positions P1 and P3 shifted from the film thickness measurement position P2 in the y-direction as illustrated in FIG. 3. When the focusing is completed, the z-coordinate and the y-coordinate of the microscope camera 14 are stored in a memory (S102). Then, the control portion 26 repeats the operation of moving the measurement unit 12 in the y-direction (S104) and Steps 5101 and 5102 until the focusing operation of the microscope camera 14 is performed for all of the height measurement positions (S103: Y).

After that, the control portion 26 moves the measurement unit 12 to the film thickness measurement position (position P2 of FIG. 3) (S105) to measure reflection intensity of polarized light (S106). Further, the control portion 26 calculates the inclination on the surface of the sample 46 at the film thickness measurement position based on the z-coordinates and the y-coordinates at the respective height measurement positions stored in Step S102, thereby calculating the corrected incident angle φ0+φ1 based on the calculated inclination (S107). Then, the control portion 26 uses the thus obtained corrected incident angle φ0+φ1 to calculate the ellipsometric parameters (Ψ, Δ) (S108). In addition, the control portion 26 uses the thus calculated ellipsometric parameters (Ψ, Δ) to calculate a film thickness value (S109). The film thickness value is displayed on, for example, a display (not shown).

According to the film thickness measurement device 10 described above, the heights of the surface of the sample 46 are measured at the plurality of height measurement positions so that the inclination on the surface of the sample 46 is calculated from the measured heights, and hence the inclination on the surface of the sample 46 caused due to the warping of the sample can be measured. Accordingly, the measurement accuracy of the film thickness can be improved. Moreover, the height of the surface of the sample 46 is measured by the microscope camera 14 for observing a spot of the measuring light, and hence the film thickness measurement device 10 can be inexpensively obtained by only changing software without the addition of any special structure.

Note that, the present invention is not limited to the above-mentioned embodiment. For example, the film thickness measurement device 10 may be configured as a spectroscopic ellipsometer instead of the single-wavelength ellipsometer. Further, a method of calculating the thickness of the film formed on the surface of the sample 46 is not limited to the above-mentioned method. Any method may be employed as long as the method uses the incident angle of the measuring light as a parameter.

Moreover, in the example described above, the procedure is described in which the focusing of the microscope camera is performed for all of the film thickness measurement positions to obtain the height information at the film thickness measurement positions in advance, and then, the measurement unit is moved to the film thickness measurement position to measure the reflection intensity of the polarized light. However, the present invention is not particularly limited thereto. For example, when the reflection intensity of the polarized light is measured in practice, for the radiation of the measuring light, the position in the height direction is adjusted through focusing with use of a focusing microscope camera so that the radiated light is unerringly focused on a radiation position on the sample surface. A method utilizing this operation may be employed.

In other words, the method does not include the step of obtaining the height information for all of the film thickness measurement positions in advance, but utilizes, as the position information of the sample in the height direction for calculating the inclination on the sample surface, the position information obtained when the position in the height direction is adjusted for the focusing at the time of measuring the reflection intensity of the polarized light. Such a method can simplify the measurement and thus is preferred.

Further, the microscope camera is described as an example of height measurement means for measuring the height of the surface of the sample, but the height measurement means may be a laser displacement meter.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A film thickness measurement device, comprising:
a light projection portion for radiating polarized measuring light on a sample;
a light reception portion for receiving reflected light of the polarized measuring light, to thereby acquire a polarization state of the reflected light;
height measurement means for measuring a height of a surface of the sample at each of a plurality of measurement positions;
inclination calculation means for calculating an inclination on the surface of the sample based on the height measured at the each of the plurality of measurement positions; and
film thickness calculation means for calculating a thickness of a film formed on the surface of the sample based on the calculated inclination on the surface of the sample and the polarization state of the reflected light.

2. The film thickness measurement device according to claim 1,
wherein the height measurement means is arranged to be movable along with a predetermined measurement reference surface, and
wherein the inclination calculation means calculates the inclination on the surface of the sample with respect to the predetermined measurement reference surface.

3. The film thickness measurement device according to claim 1, wherein the light reception portion comprises alight condensing optical system for condensing the reflected light having a traveling direction that is changeable depending on the inclination on the surface of the sample.

4. The film thickness measurement device according to claim 1, wherein the height measurement means is arranged between the light projection portion and the light reception portion, and comprises a camera for photographing a radiation position of the polarized measuring light, the height measurement means being configured to measure the height of the surface of the sample based on a result of focusing of the camera.

5. A film thickness measurement method, comprising:
radiating polarized measuring light on a sample;
receiving reflected light of the polarized measuring light, to thereby acquire a polarization state of the reflected light;
measuring a height of a surface of the sample at each of a plurality of measurement positions;
calculating an inclination on the surface of the sample based on the height measured at the each of the plurality of measurement positions; and
calculating a thickness of a film formed on the surface of the sample based on the calculated inclination on the surface of the sample and the polarization state of the reflected light.

6. The film thickness measurement device according to claim 2, wherein the light reception portion comprises alight condensing optical system for condensing the reflected light having a traveling direction that is changeable depending on the inclination on the surface of the sample.

7. The film thickness measurement device according to claim 2, wherein the height measurement means is arranged between the light projection portion and the light reception portion, and comprises a camera for photographing a radiation position of the polarized measuring light, the height measurement means being configured to measure the height of the surface of the sample based on a result of focusing of the camera.

8. The film thickness measurement device according to claim 3, wherein the height measurement means is arranged between the light projection portion and the light reception portion, and comprises a camera for photographing a radiation position of the polarized measuring light, the height measurement means being configured to measure the height of the surface of the sample based on a result of focusing of the camera.

9. The film thickness measurement device according to claim 6, wherein the height measurement means is arranged between the light projection portion and the light reception portion, and comprises a camera for photographing a radiation position of the polarized measuring light, the height measurement means being configured to measure the height of the surface of the sample based on a result of focusing of the camera.
